(19) United States
(12) Patent Application Publication
(10) Pub. No.: US 2011/0272103 A1
(43) Pub. Date: Nov. 10, 2011

(54) TAPE DISPENSER WITH SAFE CUTTING DEVICE

(75) Inventor: Massimo Mazzucchelli, Besnate (VA) (IT)

(73) Assignee: Fratelli Mazzuchelli S.p.c, Besnate (VA) (IT)

(21) Appl. No.: 13/099,862

(22) Filed: May 3, 2011

(30) Foreign Application Priority Data
May 4, 2010 (IT) MI2010A000783

(51) Int. Cl. B32B 38/10

(52) U.S. Cl. 156/510

(57) ABSTRACT

The present invention relates to a tape dispenser (1,2), comprising: a supporting frame (10, 210), a tape holding means (20, 220) for a tape (100), a cutting device (30, 230) and protective means (40, 240) of said cutting device (30, 230). The cutting device (30, 230) comprises at least one cutting portion (32, 32′, 232); the protective means (40, 240) comprise at least one protective element (42, 42′, 242, 242′) positioned corresponding with said cutting portion (32, 32′, 232). The protective element (42, 42′, 242, 242′) is permanently and statically superimposed on the cutting portion (32, 32′, 232) with respect to the direction in which the tape (100) is applied, and is oriented transversely with respect to the direction of unwinding thereof, toward the centerline (M) of the cutting device (30, 230).

The present invention relates to a tape dispenser with permanent static safe cutting device, capable of protecting the operator from dangerous accidental contacts.

Tape dispensers are devices to aid packaging operations that allow an operator to advantageously apply tape, typically with at least one adhesive side, to the surfaces concerned.

Said dispensers are generally composed of a supporting frame, a tape holding means and a cutting device. The tape, which is in roll form, is stretched by the operator through the adhesive force of the adhesive present on at least one of the two surfaces of said tape. The tape holding means supports said tape and allows unwinding thereof along the application surface. When the operation to apply the tape has terminated, the operator move the tape cutting device toward the tape to separate the portion previously unwound from the portion contained on the roll.

Numerous types of tape dispenser are known. These are usually dispensers without protective devices which, as the cutting element is constantly exposed, can cause cuts or abrasions of professional or domestic operators if their attention level decreases during operations and they come into contact with the cutting element.

Currently, some typical technical solutions to solve this problem provide for the use of a moving shield that covers said cutting element. In these solutions the moving shield exposes the cutting element upon contact with the tape, through the pressure exerted on the shield by the tape, only when the operator performs the cut. This solution has some drawbacks due to the fact that, as the moving shield is subjected to mechanical stresses, it has problems linked to wear, and problems of maintenance when the cutting element requires to be cleaned. These problems of wear consequently create problems of safety, if the shield blocks and fails to return to the covering position after making the cut, and operating problems, if the shield blocks and fails to expose the cutting element upon contact with the tape. Further solutions provide for covering of the cutting element by means of permanently housing said cutting element in a specific seat, exposing it only when two portions of tape require to be separated. These solutions have the same disadvantages as the solution indicated previously.

Some known solutions provide for sliding of the cutting device above or below the protection, or vice versa. In these cases, operation of the protective device may be compromised by the residue of adhesive deposited by the tape on the cutting device during the cutting operation.

A further disadvantage of all known technical solutions is that they require numerous elements to produce the protection, resulting in complex assembly and increased cost. EP1510491 describes an adhesive tape cutter provided with a circular blade that can be rotated, and a left and right pair of rotating protective members. Said protective members serve as tape guide rotating in a direction perpendicular to the lengthwise direction of the tape. Tape cutting is possible in the center portion of the tape in contact with the arc blade formed by the portion of the circular blade.

The device comprises several components that increase the production cost. Moreover, the protective members, and optionally even the circular blade, are not static and their wear can cause problems in the tape application. Furthermore, the central position of the circular blade combined with the lateral position of the protective members prevents to enlarge the distance between said pair of protective members while maintaining a protective function. The distance between this pair of protective members must thus be as small as possible to protect the fingers of a user.

US2009/0277942 describes a tape cutter whit a guard mechanism to prevent a finger from contacting the cutting edge of the blade. The tape cutter is provided with a sticking portion and a guard plate that can slide in the up and down direction. A pair of guard arms are configured to be opened and closed while interlocking with up and down motion of the sticking portion. Also, the dynamic elements of the device have the disadvantage of being subject to wear, and not guaranteeing a correct protection and operation. Moreover, the complexity of the device and the number of components increase the production cost. Furthermore, the dynamic elements are subject to periodic control, to guarantee the correct function when required, resulting in an increase of cost due to maintenance.

The U.S. Pat. No. 5,393,367 describes a handheld tape dispensing device in which the protection of the cutting blade is obtained by positioning a shield thereunder. The shield is connected to a spring, which in rest conditions retains it, allowing the blade to be exposed when the pressure exerted by the tape, through a flange connected to the shield, compresses the spring. The dynamic element of said device has the disadvantage of being subject to wear, and not guaranteeing correct protection and operation. A further disadvantage is the interposing of a third element, constituted by a spring, between the blade and the protection, increasing constructional complexity and related production cost.

The U.S. Pat. No. 5,456,790 describes a handheld tape dispensing device in which protection of the cutting blade is obtained by means of a protective shield, positioned above the blade. The shield is connected to the device by means of two lateral pins that allow rotation thereof, with consequent exposure of the cutting blade when the inclination of the dispenser allows unwinding of the tape to stress the shield. The moving shield provides dynamic protection and therefore has the same disadvantages listed in the previous solution.

The U.S. Pat. No. 6,296,033 describes a handheld tape dispensing device in which protection of the cutting blade is achieved through the application of a flexible covering structure of greater length than said blade. The disadvantage of this dispenser lies in the somewhat impractical nature of the system, and in the obvious danger of the element that should provide safety. In fact, the configuration and type of protection, produced through bending of a semi-elastic material such as a laminate, in relation to the intrinsic geometrical configuration of the element, could cause injuries through accidental contact with the operator, thereby defeating the purpose of the protection.

The U.S. Pat. No. 7,383,868 describes a handheld tape dispenser device in which protection of the cutting blade is provided by means of a protective shield placed above said blade. The shield is connected to the device by means of a plate with partially elastic ends which, retaining the shield in a position covering the blade, allow said shield to move over said blade when the inclination of the dispenser, and the resulting pressure generated by the tape on the shield, is such as to overcome the passive resistance of the semi-elastic elements of the plate. This solution reduces the number of components used but still has the disadvantages related to wear through use.

It would therefore be desirable to provide a tape dispenser that allows the cutting device to remain safe without movement of the protective or cutting elements. It would also be desirable for production of the protection to be advantageous, i.e. reducing the production costs of said protection.

The object of the present invention is therefore to provide a tape dispenser that is capable of maintaining the cutting device in permanent safety, preventing dangerous accidental contact with the operator during use of said dispenser.

Another object of the present invention is to provide a tape dispenser with safe cutting device on which maintenance is easy to perform.

A further object of the present invention is to provide a tape dispenser with safe cutting device such as to reduce production costs.

In accordance with the present invention, the aforesaid objects are achieved through a tape dispenser comprising: a supporting frame, tape holding means for a tape, a static cutting device and static protective means of said cutting device, characterized in that said cutting device comprises at least one cutting portion and said protective means comprise at least one protective element positioned in correspondence with said cutting portion, said protective element being permanently and statically superimposed to said cutting portion with respect to the direction in which said tape is applied, and being oriented transversely with respect to the direction of unwinding of said tape toward the centerline of said cutting device; said cutting portion being positioned on at least one side of said centerline of said cutting device.

With a tape dispenser according to the present invention there is provided a device with permanent static safety on the cutting portion, preventing accidental contact of said portion with the operator. Moreover, there is provided a tape dispenser with safe cutting device composed of a reduced number of elements not subject to fatigue wear. Furthermore, there is provided a tape dispenser with reduced cost for maintenance and suitable for all type and dimension of tape, even for tape having larger width.

Further characteristics and advantages of the present invention will be more apparent from the description of preferred embodiments, shown by way of non-limiting example in the accompanying drawings, wherein:

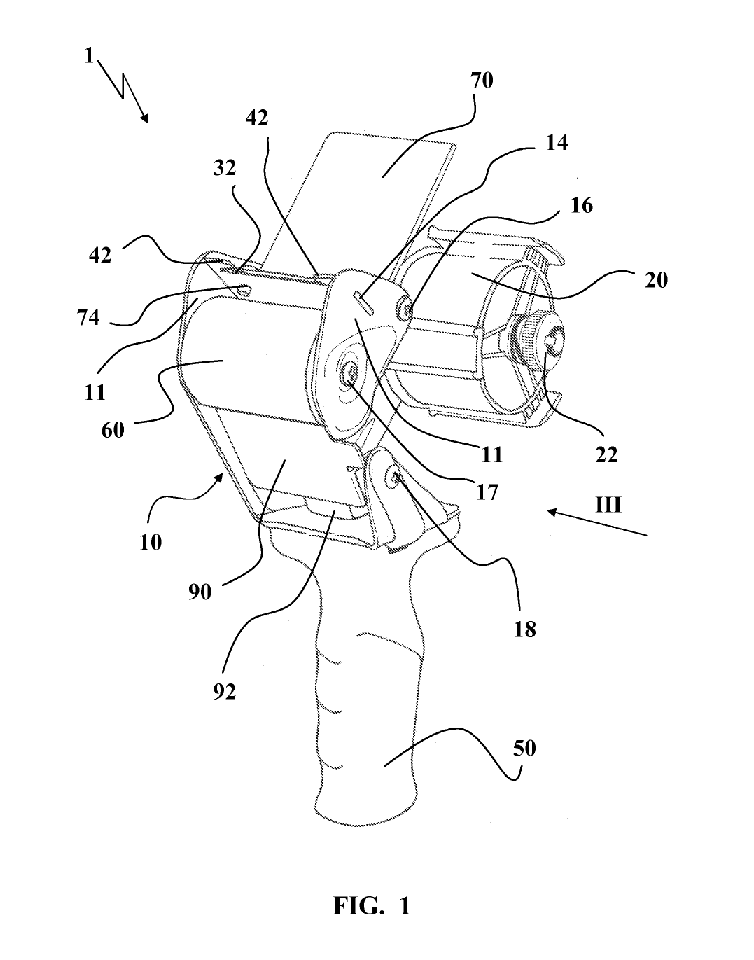

FIG. 1 shows a perspective view of an embodiment of a handheld tape dispenser with safe cutting device according to the present invention;

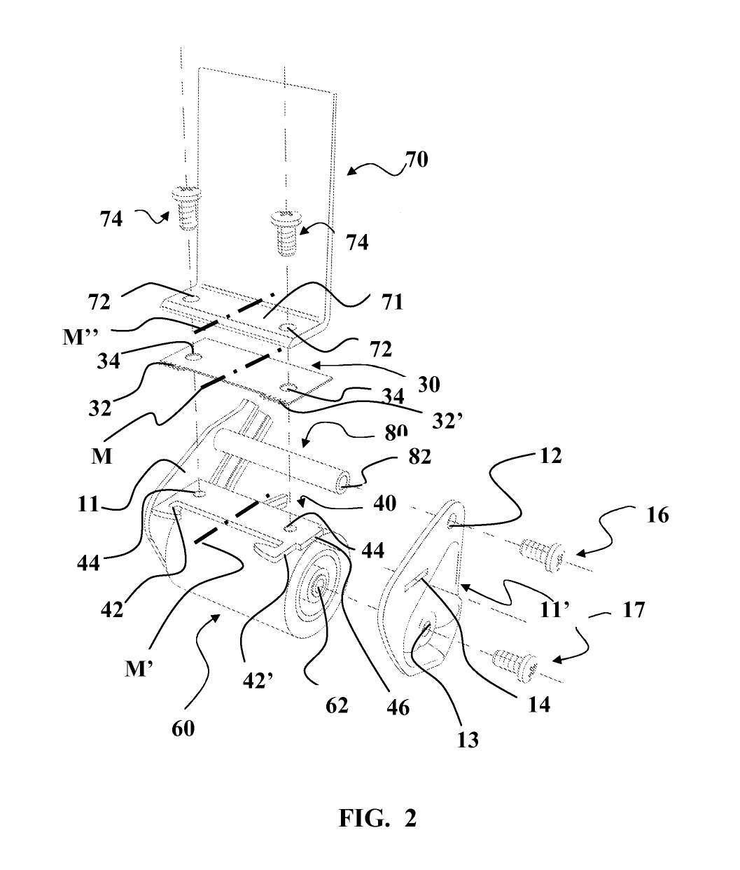

FIG. 2 shows a perspective exploded view of the embodiment of FIG. 1;

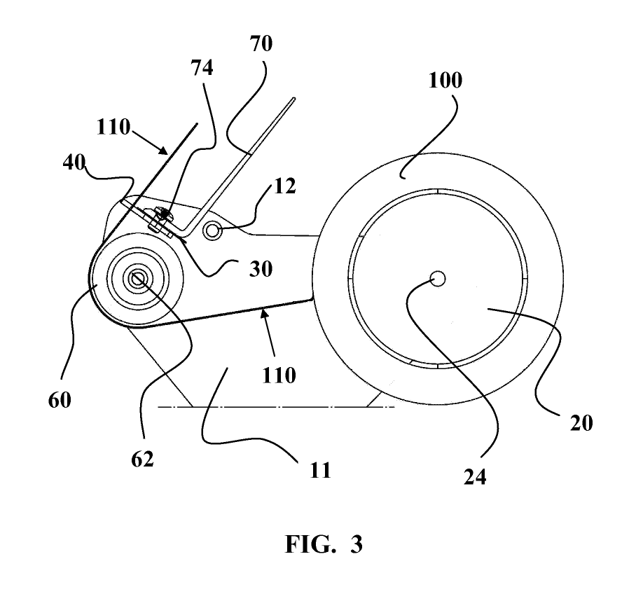

FIG. 3 shows a schematic side view of the dispenser of FIG. 1 in the direction of the arrow III, with evidence of the unwinding path of the tape;

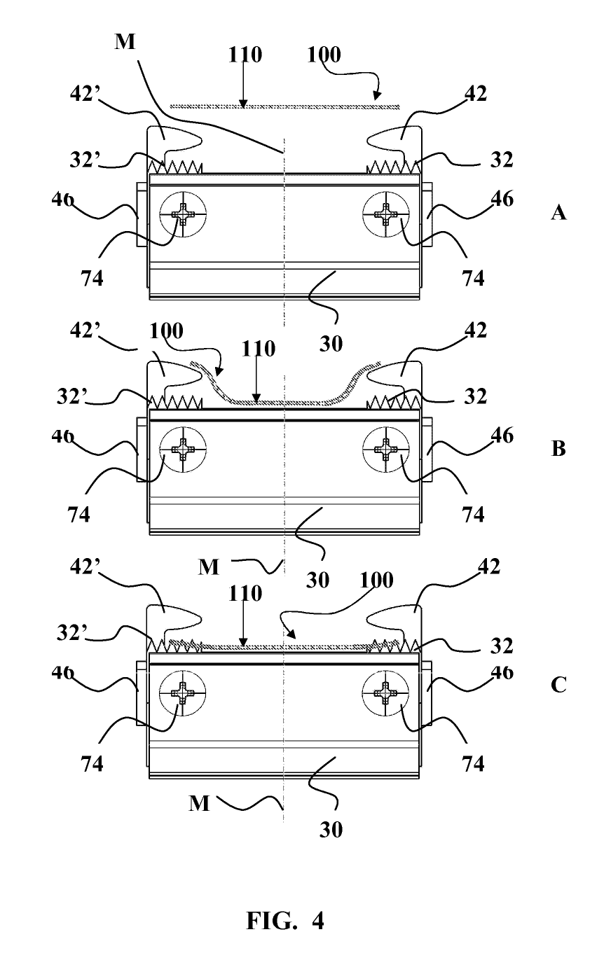

FIG. 4A schematically shows the cutting device for tape dispenser according to the embodiment of FIG. 1, during the approach step of the tape to be cut;

FIG. 4B schematically shows the cutting device for tape dispenser of FIG. 1, during the step of interposing the tape to be cut between the protective means and the cutting portion;

FIG. 4C schematically shows the cutting device for tape dispenser of FIG. 1, during the step of contact of the tape to be cut with the cutting portion;

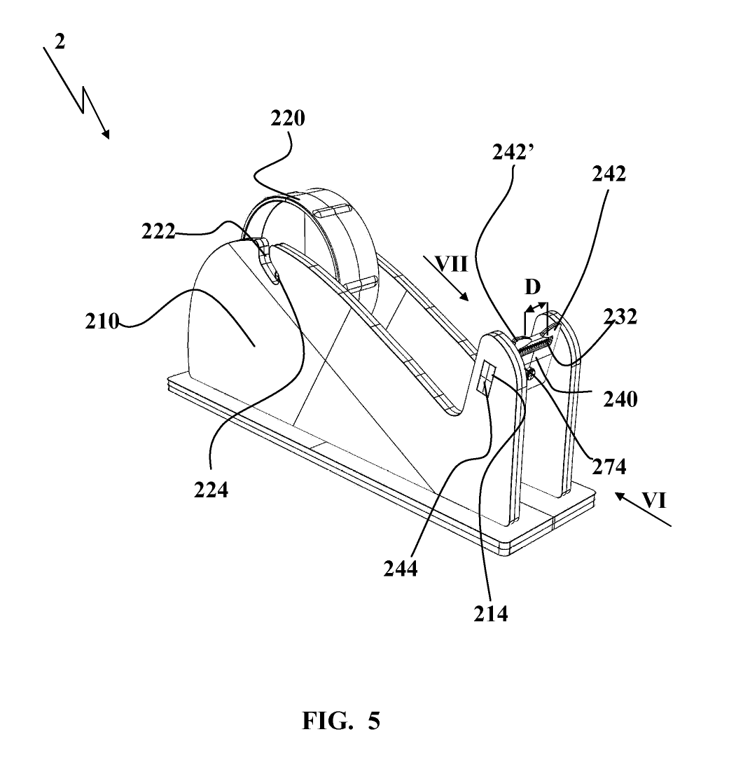

FIG. 5 shows a perspective view of a second embodiment of a desktop tape dispenser with safe cutting device according to the present invention;

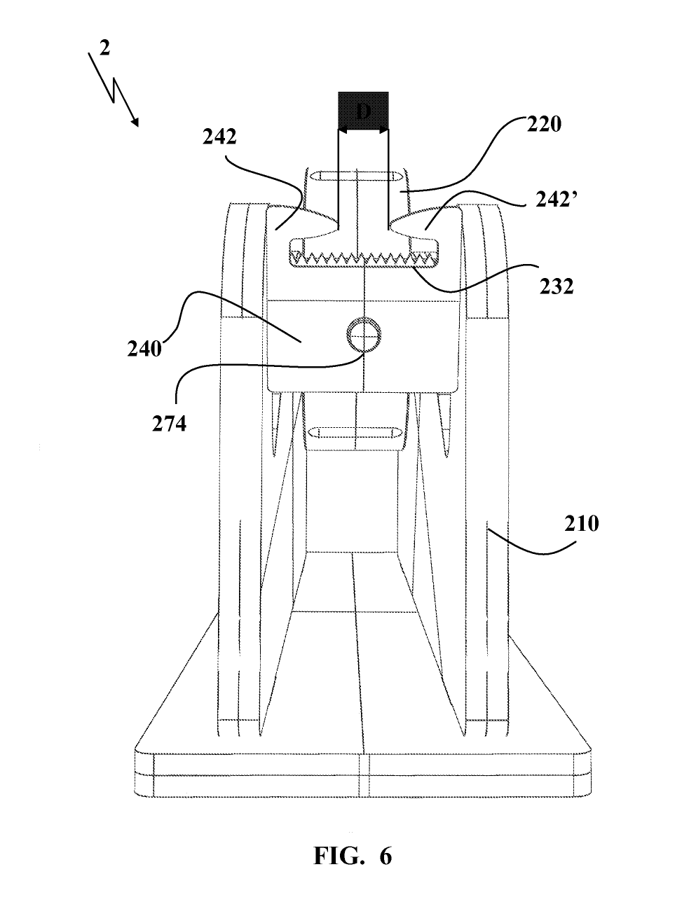

FIG. 6 shows a front view of the dispenser of FIG. 5 in the direction of the arrow VI;

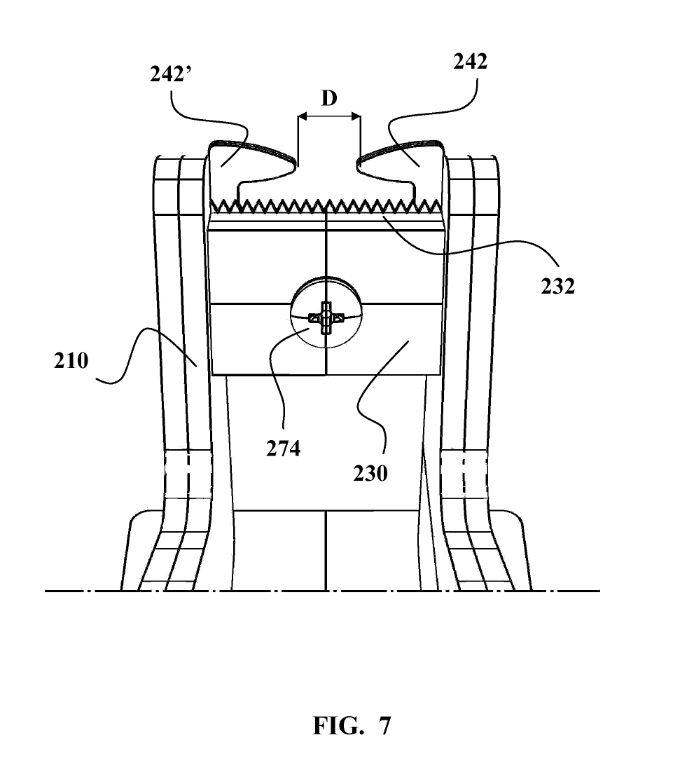

FIG. 7 shows a partial view of the dispenser of FIG. 5 in the direction of the arrow VII.

With reference to FIGS. 1, 2 and 3, the tape dispenser 1 according to the present invention comprises a supporting frame 10 composed of two lateral walls 11 and 11′, for a tape holding means 20 and for a cutting device 30. The lateral walls 11 and 11′ have a parallelepiped shaped slit 14 and two holes 12, 13. The dispenser 1 also comprises a protective means 40, integrated on which are protective elements 42, 42′ for the cutting device 30 and insertion elements 46, geometrically configured to be inserted into the slit 14 of the lateral walls 11 and 11′ of the frame 10. The protective means 40 also has two threaded holes 44, 44′, each positioned in one of the two sections with respect to the centerline (M′).

The protective elements 42, 42′ are static and are oriented transversely with respect to the direction of unwinding of the tape and are facing the centerline M′ that corresponds with the centerline M of the cutting device.

The cutting device 30 is preferably constituted by two cutting portions 32, 32′ each positioned in one of the two sections with respect to the centerline (M) of the cutting device 30. According to a preferred embodiment the cutting portions 32, 32′ are static and advantageously comprise toothed or knurled surfaces. Said cutting device 30 also has two holes 34 each positioned in one of the two sections with respect to the centerline (M).

The tape dispenser 1 according to the preferred embodiment, also comprises a handle 50, coupled with the base of the frame 10, a rubber roller 60 and a moving flange 70.

The tape holding roller 20 is coupled to the frame 10 preferably by means of a knurled threaded screw 22, capable of varying the preload and consequently the friction upon rotation of the tape holding roller 20 with respect to the pin 24.

The rubber roller 60, composed of a threaded hollow central part 62, is coupled with the lateral walls 11, 11′ of the frame 10. This coupling, which allows rotation of the rubber roller 60, is produced by means of two threaded screws 17, which pass through the specific holes 13 present in the walls 11, 11′ of the frame 10, housed inside the threaded hollow part 62 of said rubber roller.

The tape dispenser 1, according to the preferred embodiment, also comprises an L-shaped flange 70. The short side 71 of said flange 70 has two holes 72, each positioned in one of the two sections with respect to the centerline (M″) of the short side of the flange 70, through which two threaded screws 74 pass. Said threaded screws 74 also pass through the holes 34, provided on the cutting device 30 to correspond with the holes 72. The screws 74 are clamped by means of the threaded holes 44 present on the protective means 40, also arranged to correspond with the holes 72, allowing mutual coupling. Finally, coupling of the flange 70, of the cutting device 30 and of the protective means 40 to the frame 10 takes place by insertion of the protective means 40 on the lateral walls 11, 11′ of the frame. This insertion is produced by means of insertion elements 46 inserted into the slits 14 of the lateral walls 11, 110 of the frame 10 and a spacer 80, connected by two threaded screws 16 to the frame 10 by means of the two holes 12.

A moving tape retaining element 90 completes the structure of the tape dispenser 1, said retaining element 90 being connected to the frame by means of threaded screws 18, which act as pin. Said moving element 90 is operatively connected with a flexible blade 92, connected to the handle 50. The flexible blade 92 is prestressed to prevent rotation in the direction of application of the tape 100 of the moving element 90 when the tape 100 is unwound.

The tape 100 to be unwound is housed on the tape holding means 20 and initially unwound and arranged on the rubber roller 60, which has the function of facilitating application thereof. The lower surface 110 of the tape 100 is usually adhesive due to the presence of an adhesive substance. The rubber roller 60 is, in this embodiment (FIGS. 1, 2 and 3), advantageously used to affix the adhesive part 110 of the tape 100, on which the adhesive substance is present, to the desired surface, as said adhesive part 110 is facing the application surface (not shown). During application of the tape 100 to the application surface (unwinding step) the tape 100 is not in contact with the cutting device 30, and is free to unwind along the directrix of said application surface.

To separate the portion of tape 100 unwound from the remaining portion housed on the tape holding means 20, the tape 100 is placed in contact with the cutting device 30 through rotation and translation of the dispenser 1, in a direction transverse to the application surface. The rotation and translation of the tape dispenser 1 advantageously allows the use, for the cutting operation, of tensile forces that are generated on said tape 100. The adhesive substance on the adhesive side 110 maintains the tape 100 adhering to the application surface (not shown). Simultaneously, the operator applies a tensile force maintaining the tape 100 taut. The rotation and translation of the dispenser 1 allows a first contact of the tape 100 with the protective elements 42, 42′ at the end of the approach step of the portion of tape 100 to be cut (FIG. 4A). Contact with the protective elements 42, 42′ allows the tape 100, in relation to the chemical-physical properties of the material, to deform following the geometry of said protective elements 42, 42′, in the direction of the centerline (M) of the cutting device 30. The flexed portion of tape 100, free to proceed beyond said protective elements 42, 42′, will rest on the portion of the cutting device 30 not containing the cutting portions 32, 32′ (FIG. 4B). The tensile force generated along the tape 100, continuing to keep said tape 100 taut also in the presence of the deformation, allow the tape to be interposed between the protective elements 42, 42′ and the cutting portions 32, 32′. The impact of the portion of tape 100 deformed on the cutting portions 32, 32′ is such as to generate at least one point to trigger shearing of the material constituting the tape which, still being subjected to tensile force, propagates transverse to the application surface to obtain the cut.

It must be noted that the protective elements 42, 42′ have the upper edge facing downward in the direction of the centerline M to facilitate interposing of the tape between the protective elements 42, 42′ and the cutting portions 32, 32′.

A further embodiment of the tape dispenser according to the invention is shown in FIGS. 5, 6 and 7. The tape dispenser 2 shown in these figures comprises a supporting frame 210, provided with two grooves 222, joined in the end part, and with two slits 214, these latter produced in the part of the frame destined for fastening of the cutting device. The tape dispenser 2 also comprises a tape holding means 220, housed on the supporting frame 210 by means of the grooves 222. Rotation of the tape holding means 220 is produced by means of a pin 224 integral with said tape holding means 220, rotating on the joined portion of the grooves 222. The protective means 240 is provided with two protective elements 242, 242′ and with a threaded hole (not shown) positioned in the center thereof. The protective means 240 is also provided with two insertion elements 244 which allow connection thereof integral with the supporting frame 210 through insertion of the insertion elements 244 into the slits 214. The cutting device 230 comprises a cutting element 232 with surface completely knurled or serrated, provided with a hole (not shown) to correspond with the hole of the protective element 240. Coupling of the cutting element 230 to the protective element 240, and therefore to the supporting frame 210, is produced by means of a threaded screw 274 that passes through the hole of the cutting element 230 and is clamped by means of the threaded hole of the protective element 240.

In the embodiment described here the configuration of the cutting device 230 is such that the portion of flexed tape (not shown), after having moved beyond the protective elements 242, 242′, comes into contact with the cutting element 232. In this manner the tape is cut with the same methods as the previous embodiment (FIGS. 1, 2 and 3).

The protective elements 242, 242′ are positioned so as to create a separation distance D. As this separation distance D is smaller than the dimension of the fingers of an operator, it prevents any contact with the cutting portion 232, present in the projection of the separation distance D on the cutting device 230. This configuration provides an economic advantage in the construction, as the cutting portion 232 does not require any further machining after complete knurling or serration.

In further embodiments the cutting portions 32, 32′ are positioned only on one side (not shown) with respect to the centerline (M) of the cutting device 30, on both sides of said centerline (M) (FIG. 4A, FIG. 4B and FIG. 4C) or along the whole of the cutting device 232 (FIG. 5, FIG. 6 and FIG. 7). The cutting portions 32, 32′ according to the preferred embodiment, are composed of toothed or knurled surfaces. Further non-exclusive embodiments are provided with smooth surfaces, such as a blade (not shown). Preferably, the cutting device 30 and the protective elements 42, 42′, 242, 242′ are produced through two different coupled elements; further non-exclusive embodiments provide for the joint presence of said cutting device 30 and of said protective elements 42, 42′, 242, 242′ on a single element (not shown) or incorporation of said protective elements 42, 42′, 242, 242′ on the supporting frame 10, 210.

With the technical and technological solutions adopted for the tape dispenser with safe cutting device it is possible to fully achieve the stated aim and objects. In particular, the use of static elements allows safe use by the operator even in conditions of low attention level during operations. Moreover, due to the absence of mechanisms to produce the protection and the noteworthy reduction in constituent elements it is possible to eliminate problems related to fatigue wear and to reduce production and assembly costs.

The tape dispensers 1, 2 have a structure that is relatively simple and inexpensive to produce with known industrial processes. They are susceptible to numerous modifications and variants, all falling within the scope of the same inventive concept, as defined in the accompanying claims.

1. A tape dispenser comprising: a supporting frame, tape holding means for a tape, a static cutting device and static protective means of said cutting device, wherein said cutting device comprises at least one cutting portion and said protective means comprise at least one protective element positioned in correspondence with said cutting portion, said protective element being permanently and statically superimposed to said cutting portion with respect to the direction in which said tape is applied, and being oriented transversely with respect to the direction of unwinding of said tape toward the centerline of said cutting device; said cutting portion being positioned on at least one side of said centerline of said cutting device.

2. The tape dispenser according to claim 1, wherein it comprises two cutting portions, positioned at the sides of the centerline of said cutting device, and two protective elements, positioned at the sides of the centerline of said protective means, corresponding with the centerline of said cutting device.

3. The tape dispenser according to claim 1, wherein said cutting device and said protective means are coupled integrally in such a manner as to prevent relative movements.

4. The tape dispenser according to claim 1, wherein said cutting device and said protective means are comprised in a single element.

5. The tape dispenser according to claim 1, wherein said cutting portion extends entirely with continuity on the cutting device.

6. The tape dispenser according to claim 5, wherein said protective elements have a lesser width than said cutting portion.

7. The tape dispenser according to claim 1, wherein said protective elements are separated by a separation distance intended to be smaller than the dimension of the fingers of an operator.

8. The tape dispenser according to claim 2, wherein said cutting device and said protective means are coupled integrally in such a manner as to prevent relative movements.

9. The tape dispenser according to claim 2, wherein said cutting device and said protective means are comprised in a single element.

10. The tape dispenser according to claim 3, wherein said cutting device and said protective means are comprised in a single element.

11. The tape dispenser according to claim 2, wherein said cutting portion extends entirely with continuity on the cutting device.

12. The tape dispenser according to claim 3, wherein said cutting portion extends entirely with continuity on the cutting device.

13. The tape dispenser according to claim 4, wherein said cutting portion extends entirely with continuity on the cutting device.

14. The tape dispenser according to claim 2, wherein said protective elements are separated by a separation distance intended to be smaller than the dimension of the fingers of an operator.

15. The tape dispenser according to claim 3, wherein said protective elements are separated by a separation distance intended to be smaller than the dimension of the fingers of an operator.

16. The tape dispenser according to claim 4, wherein said protective elements are separated by a separation distance intended to be smaller than the dimension of the fingers of an operator.

17. The tape dispenser according to claim 5, wherein said protective elements are separated by a separation distance intended to be smaller than the dimension of the fingers of an operator.

18. The tape dispenser according to claim 6, wherein said protective elements are separated by a separation distance intended to be smaller than the dimension of the fingers of an operator.

19. The tape dispenser according to claim 8, wherein said cutting device and said protective means are comprised in a single element.

20. The tape dispenser according to claim 8, wherein said cutting portion extends entirely with continuity on the cutting device.
